(19) United States
(12) Patent Application Publication
(10) Pub. No.: US 2002/0176768 A1
(43) Pub. Date: Nov. 28, 2002

(54) Towed tow bed modular vehicle carrier apparatus, system, and method

(75) Inventor: Lynn D. Stomski, Ballstonn Spa, NY (US)

Correspondence Address: LAW OFFICE OF JAY R. YABLON, 910 NORTHUMBERLAND DRIVE, SCHENECTADY, NY, 12309-2814, US

(73) Assignee: Stomper Designs, Inc., Saratoga, NY (US)

(21) Appl. No.: 10/064,656

(22) Filed: Aug. 2, 2002

Related U.S. Application Data
(60) Provisional application No. 60/383,541, filed on May 28, 2002.

(51) Int. Cl. B60P 1/28

(52) U.S. Cl. 414/485

(57) ABSTRACT

A method of using a wheel lift towing vehicle to carry vehicles as a vehicle-carrying towing vehicle is disclosed. A modular vehicle carrier comprising a tow bed of sufficient dimension and constitution to carry at least one automotive vehicle thereupon is mated with a wheel lift device of the wheel lift towing vehicle. The tow is tilted bed into a position for vehicle loading and unloading by raising the wheel lift device, and into a position for travel by lowering the wheel lift device. Also disclosed is a related modular vehicle carrier apparatus comprising: a tow bed of sufficient dimension and constitution to carry at least one automotive vehicle thereupon; wheel lift mating means for mating said tow bed with a wheel lift device of a wheel lift towing vehicle; and tilting means for enabling the mated wheel lift device to tilt said tow bed into a position for vehicle loading and unloading by raising said wheel lift device, and for enabling said wheel lift device to tilt said tow bed into a position for travel by lowering said wheel lift device.

### CROSS REFERENCE TO RELATED APPLICATIONS

This application claims priority benefit from provisional application U.S. 60/383,541, filed May 28, 2002.

### BACKGROUND OF INVENTION

Motorists from time to time find themselves in the unhappy position of needing to have their vehicles towed, due to a breakdown or similar non-functioning of their vehicles. While some vehicles can be towed with two wheels on the road, many other vehicles (four-wheel drive vehicles, for example) cannot. These vehicles must be towed on a flatbed deck/vehicle carrier, where all wheels of the vehicle are off the road. This means that tow service operators typically must purchase and maintain two vehicles: first, a conventional tow truck with a “wheel lift” such as the widely used “T” bar; second, a flatbed truck with complex hydraulics used to tilt the rear of vehicle-carrying deck so that vehicles on the road may be readily pulled up onto the deck. Once the vehicle(s) are atop the deck, the deck is returned to a position parallel with the road, and can then be driven from one location to another with the vehicles in carriage.

It would be desirable if the operator of a towing service could avoid having to maintain two separate vehicles in the manner discussed above. Rather, it would be preferred to maintain only a single vehicle, namely, a conventional tow truck, and, by use of a suitable conversion module, to convert the tow truck into a configuration for flatbed towing when desired, and even into a combination flatbed / wheel lift device.

### SUMMARY OF THE INVENTION

Disclosed herein is a method of using a wheel lift towing vehicle to carry vehicles as a vehicle-carrying towing vehicle. A modular vehicle carrier comprising a tow bed of sufficient dimension and constitution to carry at least one automotive vehicle thereupon is mated with a wheel lift device of the wheel lift towing vehicle. The tow bed is tilted into a position for vehicle loading and unloading by raising the wheel lift device, and into a position for travel by lowering the wheel lift device. Also disclosed is a related modular vehicle carrier apparatus comprising: a tow bed of sufficient dimension and constitution to carry at least one automotive vehicle thereupon; wheel lift mating means for mating said tow bed with a wheel lift device of a wheel lift towing vehicle; and tilting means for enabling the mated wheel lift device to tilt said tow bed into a position for vehicle loading and unloading by raising said wheel lift device, and for enabling said wheel lift device to tilt said tow bed into a position for travel by lowering said wheel lift device.

### BRIEF DESCRIPTION OF THE DRAWINGS

The features of the invention believed to be novel and nonobvious are set forth in the appended claims. The invention, however, together with further objects and advantages thereof, may best be understood by reference to the following description taken in conjunction with the accompanying drawing(s) in which:

FIG. 1 is a perspective view illustrating a modular vehicle carrier in a preferred embodiment.

FIG. 2 is a side plan view illustrating the modular vehicle carrier of FIG. 1 when is it moved into a position to load and unload vehicles.

FIG. 3 is a side plan view illustrating the modular vehicle carrier of FIG. 1 when is it moved into a position to carry (travel with) vehicles, or to travel without vehicles.

FIGS. 4 and 5 are respective perspective and side plan views illustrating a particular embodiment for attaching and securing the modular vehicle carrier to a towing vehicle.

FIG. 6 is a perspective view illustrating a tow bed headboard in a preferred embodiment.

### DETAILED DESCRIPTION

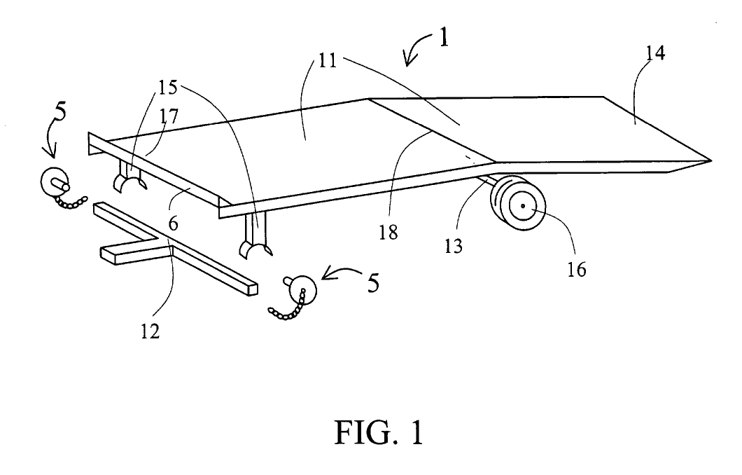

A modular vehicle carrier 1 with a “Tow Bed” 11 as disclosed herein and illustrated in FIG. 1 increases the vehicle-carrying capacity by at least one vehicle, of a wheel lift towing vehicle 2 such as a conventional tow truck with a wheel lift 12 such as a “T” bar. Importantly, it also enables a conventional wheel lift towing vehicle to load, unload, and carry vehicles 21, such as four-wheel drive vehicles, that cannot be towed in the conventional manner with any wheels touching the road 22.

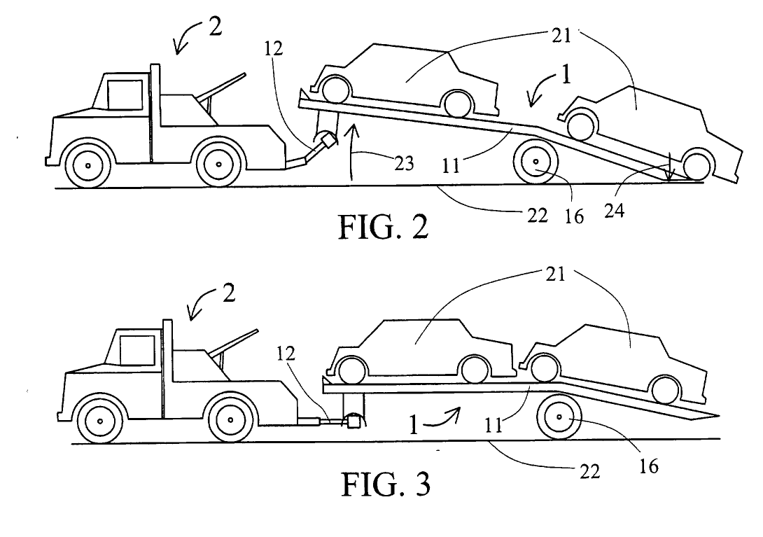

Modular vehicle carrier 1 herein disclosed is a vehicle carrier/flatbed for one or more vehicles 21 that is pulled by either a towing vehicle 2 or another vehicle carrier (such as a conventional flatbed truck, not shown, with a wheel lift 12 attached at the back end thereof) by attaching modular vehicle carrier 1 to a wheel lift 12, e.g., “T”bar of the towing vehicle 2 or other vehicle carrier. The normal function of a wheel lift 12 on a towing vehicle 2 or other vehicle carrier is to attach and secure a vehicle that is being towed. To do this the wheel lift 12 raises and lowers the vehicle to be towed by using power supplied by towing vehicle 2. In accordance with the invention, when modular vehicle carrier 1 with tow bed 11 is attached to wheel lift 12 as shown generally in FIGS. 2 and 3, this same range of motion allows for the lifting 23 of the front end 17 of the tow bed 11 thus causing the rear end 14 of tow bed 11 to descend 24 until it substantially touches the road 22 allowing for the loading/unloading of vehicles 21, as shown in FIG. 2. This occurs because of the design of the tow bed 11 deck, including a bend at 18 and the placement of a wheel axle 13 thereof that serves as a pivot point. After loading/unloading of vehicles, wheel lift 12 lowers the front end 17 of tow bed 11 in the same way that it lowers a towed vehicle in ordinary operation, thus raising the rear end 14 of tow bed 11 to allow for normal over the road usage. Winches and/or cranes (not shown) on the towing vehicle 2 or vehicle carrier perform the positioning of the vehicles to be carried, in a manner customary in the art. Importantly, there are no hydraulics or lifting equipment on modular vehicle carrier 1 itself, thus making it modular and inexpensive to manufacture and maintain. All of the lifting hydraulic or other means in supplied by the towing vehicle 2 or other vehicle carrier via its wheel lift 12.

Modular vehicle carrier 1 is a simple, unitary device that does not require any built-in hydraulics or similar means for tilting. Modular vehicle carrier 1 comprises a substantially flat, vehicle-carrying tow bed 11 deck thereof (with the bend illustrated at 18), a wheel axle 13 that can be secured to tires 16 as shown about which the tow bed may be tilted when the front end 17 of tow bed 11 is raised and lowered, and a mating means 15 such as the illustrated tow leg for mating with a wheel lift 12, such as but not limited to, the ordinary “T” bar-type vehicle lift of an ordinary towing vehicle 2 (e.g., tow truck).

Modular vehicle carrier 1 including tow bed 11 takes novel and non-obvious advantage of the fact that wheel lifts 12 already are designed to be moved up and down to raise and lower a vehicle that is being towed with two wheels raised and two wheels on the road. In particular, modular vehicle carrier 1 mates with this very same wheel lift 12 of the towing vehicle 2 via the illustrated mating means 15 such as a tow leg, and takes advantage of this very same up and down wheel lift movement to raise and lower the front end 17 of the tow bed 11 so that the back end 14 of tow bed 11 contacts the road 22 and one or more vehicles 21 can then be loaded onto and unloaded off of tow bed 11. In addition, once the vehicle(s) 21 have been loaded on tow bed 11 (or when tow bed 11 is empty and simply needs to be pulled), the towing vehicle 2 (or other carrier with a wheel lift) pulls tow bed 11 via this mated connection 31 between wheel lift 12 and mating means 15, e.g., the tow leg, so that wheel lift 12 further serves as a tow “hitch.” In this way, the ordinary wheel lift 12 of a towing vehicle 2 or other vehicle carrier replaces the complex and costly hydraulic systems that are normally used to tilt tow beds for loading and unloading. Thus, a person who owns an ordinary towing vehicle does not need to incur the expense of purchasing a wholly separate flatbed truck with complex tilting mechanisms for loading and unloading vehicles. They need only purchase the simple, low cost modular vehicle carrier 1 of FIG. 1 for attachment to their pre-existing towing vehicle 2.

Wheel lift 12 is thereby used in a novel and non-obvious manner to serve three distinct functions: 1) it is an ordinary wheel lift when modular vehicle carrier 1 including tow bed 11 is not attached; 2) it provides the lifting and descending motion to tow bed 11 to tilt tow bed 11 for vehicle loading and unloading and thereby replaces and enables omission of the separate hydraulic or similar systems that are normally used to cause this tilting; and 3) it serves as a trailer hitch to move (e.g., pull) tow bed 11 for travel, with or without vehicles 21 atop.

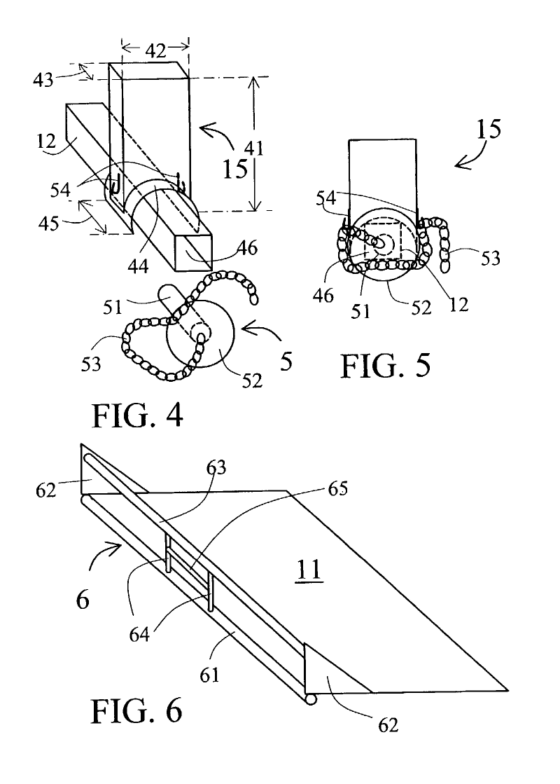

FIGS. 1-3 illustrate a particular means for mating wheel lift 12 to tow bed 11 which employs mating means 15 comprising the illustrated tow leg, and FIGS. 4 and 5 further show a particular means for securing this tow leg to wheel lift 12. But, it is understood that this is but one example of a variety of conceivable ways in which the mating between wheel lift 12 and tow bed 11 can take place, and it is understood that a broad range of options for mating wheel lift 12 to tow bed 11 to enable wheel lift 12 to tilt tow bed 11 for loading and unloading, and to pull tow bed 11 otherwise, are considered to be within the scope of this disclosure and its associated claims. Tow leg 15, as well as the means to secure tow leg 15 to wheel lift 12 can be varied within the scope of this disclosure and its associated claims, so long as the wheel lift 12 is capable of raising (FIG. 2) and lowering (FIG. 3) the front end 17 of tow bed 11, and of pulling tow bed 11 when it is in the lowered (FIG. 3) position. When vehicle carrier 1 is unattached to a towing vehicle, its front end 17 is supported with respect to the ground by tow leg 15.

Thus, the disclosed method of loading, unloading and towing at least one vehicle 21 on a tow bed 11, comprises the steps of: mating (via mating means 15) the tow bed 11 to a wheel lift device 12 of a towing vehicle or an other carrier 2 (as illustrated, or by any of a variety of means for achieving a similar mating function); tilting 23 the mated tow bed into a position to load and unload the at least one vehicle by raising the wheel lift device 12 (as in FIG. 2 generally); and tilting the mated tow bed into a position to tow the at least one vehicle 21 by lowering the wheel lift device 12. Additionally, the mated tow bed (with or without vehicles atop) is pulled by the towing vehicle 2 or other carrier via its mating with the wheel lift device 12.

The disclosed modular vehicle carrier 1 comprises wheel lift mating means (again, as illustrated, or by any of a variety of means for achieving a similar mating function) for mating the tow bed 11 to a wheel lift device 12 of a towing vehicle or other carrier 2, wherein: the tow bed 11, when mated (via 15) with the wheel lift device 12, is tilted 23 into a position to load and unload at least one vehicle 21 by raising the wheel lift device 12; and the tow bed 11, when mated (via 15) with the wheel lift device 12, is tilted into a position to tow the at least one vehicle 21 by lowering the wheel lift device 12. Additionally, the mated tow bed (with or without vehicles 21 atop) is pulled by the towing vehicle 2 or other carrier via its mating with the wheel lift device 12. Also shown in FIG. 1 is a securing means 5, to be discussed below with reference to FIG. 5.

A key element of this invention is thus the mating of the tow bed 11 to a wheel lift “T”bar 12, and as stated above, many options may be chosen within the scope of this disclosure and its associated claims to implement this mating. One such option uses tow legs 15, as illustrated and discussed herein, in detail.

In the particular mating implementation illustrated, which is to be regarded as an example and not to be interpreted as limiting, there are two tow legs under tow bed 11. All dimensions are approximate and illustrative and allow for significant variation within the scope of the disclosure and the associated claims. As illustrated in FIG. 4, mating means 15 comprise a tow leg which is approximately 18″ high (41), 3″ wide (42) (along the vehicle carrier 1 width) and 6″ long (43) (along the vehicle carrier 1 length) using approximately ¼ inch thick rectangular steel tubing or any equivalent. The tops of tow legs 15 are welded to the underside of a 3×6×¼ inch rectangular tube frame rail, not shown, that is positioned on end for strength and runs the length of tow bed 11. Each tow leg 15 is positioned, on center, approximately 36″in from front end 17 of tow bed 11 and approximately 40″in from its respective side. A concave bottom section (tow leg saddle 44) of tow leg 15 is made, for example, not limitation, from a 6″diameter standard pipe that is welded to it. A 6″ diameter pipe, uncut, has a circumference of approximately 19″, and thus such a pipe cut in half would have an approximately 9.5″ circumference. This 6″pipe is cut so that it has an approximately 11″ circumference, which means that a little more than half the pipe is utilized and that the lower ends of concave bottom section 44 thus curve back inward slightly. The pipe is approximately 6″running parallel to the vehicle carrier 1 width along 45 and is attached in such a manner that the end is concave and looks like a saddle. The 6″long bottom pipe end of the tow leg 15 is centered on and protrudes 1 ½″on either side of the 3″ wide rectangular tube portion of tow leg 15. This allows tow leg 15 to rest on top of the wheel lift 12 “T”bar like a “saddle,” 44.

Link chain securing means 54 for securing link chain 53 to be discussed shortly are welded on the centerline of a tow leg and 3″up from the bottom on the side facing the front end of a tow bed, and also on the centerline on the rear side of the tow leg and 3″up from the bottom of a tow leg.

As now illustrated in FIG. 5, in reference to FIG. 4 which provides a perspective view, tow leg 15 is attached to the wheel lift 12 “T”bar using securing means 5 for securing mating means 15 such as the tow leg to wheel lift 12. Securing means 5 comprises a securing center pin 51 which is inserted into a hollow square end 46 of the wheel lift 12 “T”bar while the tow leg saddle 44 is resting on it. Securing center pin 51 comprises an approximately 2″diameter standard pipe, peg, or suitable equivalent, and is approximately 6″long. A lateral securing means such as the illustrated circular approximately ¼″thick steel securing plate 52 with an approximately 6″ diameter is welded, substantially on center, to the outside end of a center pin pipe 51. Welded to the outside center securing plate 52 is an approximately 36″length of 5/16″link chain 53 or suitable equivalent securing apparatus. Link chain 53 is hooked onto a 5/16″grab hook or equivalent link chain securing means 54 on a first position on tow leg 15 (in the illustration, on the front side of the tow leg 15) for securing link chain 53, such that securing plate 52 is firmly seated against the hollow square end 46 of the wheel lift 12 “T”bar. This is done for both ends 46 (first end and second end) of the “T” bar. The rest of link chain 53 is then dropped under and around the wheel lift 12 “T”bar and the bottom of the tow leg saddle 44 and attached to the second link chain securing means 54 on a second position (in the illustration, the rear side) of tow leg 15 such that wheel lift 12 “T”bar and tow leg 15 are firmly secured together. This serves to secure tow leg 15 to wheel lift 12 “T” bar such that 1) the “T” bar will not sway from side to side (laterally) relative to tow leg 15 because of securing plates 52, and “T” bar will be vertically secured relative to tow leg 15 because of the section of link chain 53 residing under the “T” bar.

Other dimensions of interest which are provided for illustration, not limitation, are the following: Tow bed 11 is optimally about 28″ in length and about 90″-96″wide. Modular vehicle carrier 1 comprises an approximately 10,000 lbs dual wheel axle 13 and approximately 16″rims. dual wheel axle 13 is located approximately 16″ from front end 17 and approximately 12″ from the rear end 14 of tow bed 11. Tow bed 11 deck comprises 3/16″plate steel, or, if desired, aluminum, or any other suitable equivalent material.

Tow bed 11 deck is welded to 3″×3/16″standard channel cross braces, not shown, under it which are located every 12″ on center. The cross braces are welded transversely to the top of two longitudinal 3×6×¼ inch rectangular tube frame rails, not shown, that are oriented so the top and bottom surface is 3″wide and the sides, which are perpendicular to the road, are 6″.

Tow bed 11 deck, in the over the road trailer position, is horizontal, i.e., parallel to the road 22, for the first 16″ from its front end 17 back to a location proximate wheel axle 13. It is approximately 36″high off of the road 22. From that point proximate wheel axle 13 and for 12″ to the rear end of a tow bed, at tow bed bend 18, tow bed deck 11 declines in a straight line to a height of 18″off the road. Thus, it drops for a 1.5 foot rise over a 12 foot run for an approximately ⅛ grade A 3×6×¼″frame rail, not shown, is bent or mitered in a downward angle at the wheel axle to accommodate the rear deck decline and is tapered at the rear end.

As illustrated in FIG. 6, tow bed 11 deck may comprise a headboard 6, mounted transversely on the front end of the deck. Headboard 6 allows a vehicle to be braced and secured to it and prevents it from rolling off the front of a tow bed.

Headboard 6 is the width of a tow bed deck. In a 90″wide deck there is a 3″standard pipe 90″long or equivalent base attachment 61 welded to the front edge of the deck plate with the top of the pipe being on substantially the same plane as the deck. Welded to a deck plate at the leading edge of a tow bed and abutting the 3″pipe are two solid ¼″sheet steel 8″ right triangles or substantial equivalents 62. A right triangle is welded on both outside edges of a deck. A 1 ¼″standard pipe 89 ½″long or equivalent upper transverse member 63 is butt-welded to the inside top part of the two 8″right triangles which serve as end caps.

A center upper and lower loading/unloading cable guide is formed by welding two 7 ½″long 1 ¼″standard pipes or equivalent upright members 64 in a vertical position each one 36″in from the outside edge of a deck and into notches provided in the 3″standard pipe on the bottom and the 1 ¼″standard pipe on the top. A 1 ¼ standard pipe 17″long, with contoured ends to fit the vertical pipes, or equivalent crossing member 65 is welded to them 3 ¾″on center between and parallel to the top and bottom pipes.

There are eight tie down anchor chain slots, not shown, on the deck of a tow bed. Two slots are located 12″in from the front end of a tow bed and 6″in from each outside edge. Two slots are located 12″in from the rear of a tow bed and 6″in from each outside edge. There are four slots located near the midway point between the front and rear ends of a tow bed. Two of the slots are 6″forward of the mid point and 6″in from the outside edge of a tow bed and two slots are 6″ to the rear of the mid point and are 6″in from the outside edge of a tow bed.

There is a standard brake, directional and night-light package available, not shown.

There are stake pockets, not shown, provided on the outside edges of the tow bed deck for optional side rails, not shown.

A standard fold down leg stand or landing gear, not shown, can be provided that is mounted behind the tow leg.

The tow bed itself may comprise its own, optional wheel lift, not shown, so that a vehicle can be towed with two wheels elevated and two wheels on the road, behind the tow bed, or so that an additional such tow bed can be added in a “train” configuration consistently with vehicle safety requirements and so long as the towing vehicle has sufficient power.

The bend 18 in tow bed 11 is positioned and angled, and located proximate wheel axle 13, such that a region of tow bed 18 forward of bend 18 is substantially parallel to the road 22 when the tow bed 11 is in the position for travel (FIG. 3), and a rear end 14 of tow bed 11 aft of bend 18 substantially contacts road 22 when tow bed 11 is in the position for loading and unloading (FIG. 2), when said module vehicle carrier is attached to tires 16 thereof via wheel axle 13. The various dimensions and bend angles of this arrangement can be varied, so long as this fundamental functionality (raise to load and unload, lower to travel) is achieved.

The vertical “rise” of a typical wheel lift, combined with the height of tires that are of a suitable diameter for use on the tow bed, further combined with the need to tilt the tow bed so that its back end touches the road for loading and unloading when its front end is raised, and further combined with the need to place the tires in a fore-aft position that optimizes the balance of the tow bed when loaded and unloaded, all serve to determine an optimal length for the tow bed as specified above, as well and the optimal location for wheel axis 13 and the tow bed bend 18. This optimal length turns out to be suitable for carrying two vehicles on the tow bed, and if the tow bed has its own optional wheel lift at the back, this can be used to tow a third vehicle in the traditional manner with one wheel pair down and one wheel pair elevated, or to add an other tow bed in a train as noted above.

The use of a wheel lift “T” bar serves to stabilize the tow bed, because such a T bar is typically at least as wide as the separation between two vehicle tires on a single axle, and thus provides stability against “twisting” that could occur, for example, with a mere “ball” hitch.

It is to be understood that the use of the term “towing vehicle” and variations thereof is to be understood differently than the use of the term “vehicle” by itself or in a context other than that of the towing vehicle. In particular, the latter usage is to be understood to refer to vehicles that are to be towed by the towing vehicle.

While it is preferable that wheel lift 12 be used not only to raise and lower modular vehicle carrier 1 for loading/unloading and travel, but also to pull modular vehicle carrier 1 during travel, it is not essential that this occur. It is to be considered within the scope of this disclosure and its associated claims that someone might make use of a different form of connection between towing vehicle 2 and modular vehicle carrier 1 for the purpose of pulling modular vehicle carrier 1 along the road versus raising and lowering modular vehicle carrier 1, even though this gives up the advantage of using wheel lift 12 as a hitch for travel as well as as a lift for loading/unloading.

While towing vehicle 2 will often be a conventional tow truck with a wheel lift 12, it is understood that towing vehicle 2 may comprise any vehicle comprising a wheel lift device 12, including, for example, an ordinary flatbed carrier with a wheel lift 12 on its back. In this latter situation, attaching the wheel lift 12 at the back of the flatbed carrier to modular vehicle carrier 1 establishes a “train,” and thereby adds to the vehicle-carrying capacity of the flatbed carrier.

While only certain preferred features of the invention have been illustrated and described, many modifications and changes will occur to those skilled in the art. It is, therefore, to be understood that the appended claims are intended to cover all such modifications and changes as fall within the true spirit of the invention.

1. A method of using a wheel lift towing vehicle to carry vehicles as a vehicle-carrying towing vehicle, comprising the steps of:
mating a modular vehicle carrier comprising a tow bed of sufficient dimension and constitution to carry at least one automotive vehicle thereupon, with a wheel lift device of said wheel lift towing vehicle;
tilting said tow bed into a position for vehicle loading and unloading by raising said wheel lift device; and
tilting said tow bed into a position for travel by lowering said wheel lift device.

2. The method of claim 1, further comprising the step of:
when said tow bed is in said position for travel, causing said tow bed and any vehicles thereon to travel using said wheel lift device as a hitch therefor.

3. The method of claim 1, further comprising the steps of:
loading a vehicle onto said tow bed when said tow bed is in said position for vehicle loading and unloading;
causing said tow bed and said vehicles thereon to travel using said wheel lift towing vehicle, when said tow bed is in said position for travel; and
unloading said vehicle from said tow bed when said tow bed is in said position for vehicle loading and unloading.

4. The method of claim 3, the step of traveling using said wheel lift towing vehicle further comprising the step of:
causing said tow bed and any vehicles thereon to travel using said wheel lift device as a hitch therefor.

5. The method of claim 1, said step of tilting further comprising:
tilting said tow bed into said position for travel about a wheel axle positioned such that raising said wheel lift device tilts said tow bed into said position for vehicle loading and unloading and lowering said wheel lift device.

6. The method of claim 2, said step of tilting further comprising:
tilting said tow bed into said position for travel about a wheel axle positioned such that raising said wheel lift device tilts said tow bed into said position for vehicle loading and unloading and lowering said wheel lift device.

7. The method of claim 2, the step of traveling further comprising:
moving said mated wheel lift device by similarly moving said tow bed, using tires secured to a wheel axle.

8. The method of claim 4, the step of traveling further comprising:
moving said mated wheel lift device by similarly moving said tow bed, using tires secured to said wheel axle.

9. The method of claim 1, further comprising the step of:
maintaining a region of said tow bed forward of a bend in said tow bed substantially parallel to a road when said tow bed is in said position for travel, and substantially contacting a rear end of said tow bed aft of said bend to said road when said tow bed is in said position for loading and unloading, when said module vehicle carrier is attached to tires thereof via a wheel axle of said modular vehicle carrier, by a positioning and angling of said bend, and by locating said bend proximate said wheel axle.

10. The method of claim 1, said step of mating comprising:
securing at least one tow leg to said wheel lift device using securing means for securing said tow leg to said wheel lift device.

11. The method of claim 10, said step of securing:
substantially preventing said at least one tow leg from moving laterally relative to said wheel lift device, using lateral securing means therefor; and
substantially preventing said at least one tow leg from moving vertically relative to said wheel lift device using vertical securing means therefor.

12. The method of claim 11:
the step of preventing lateral movement comprising securely connecting a first said tow leg with a first end of said wheel lift device comprising a “T” bar, and a second said tow leg with a second end of said “T” bar, using lateral securing means therefor; and
the step of preventing vertical movement comprising connecting at least one securing apparatus from a first position on at least one of said tow legs, securely beneath said “T” bar, to a second position on said at least one of said tow legs, using vertical securing means therefor.

13. The method of claim 1, further comprising the step of:
sufficiently dimensioning and constituting said tow bed to carry at least two automotive vehicles thereupon.

14. The method of claim 9, further comprising the step of:
sufficiently dimensioning and constituting said tow bed to carry at least two automotive vehicles thereupon.

15. The method of claim 1, said step of mating said modular vehicle carrier with said wheel lift device of said wheel lift towing vehicle further comprising the step of mating said modular vehicle carrier with said wheel lift device of a conventional tow truck.

16. The method of claim 1, said step of mating said modular vehicle carrier with said wheel lift device of said wheel lift towing vehicle further comprising the step of mating said modular vehicle carrier with said wheel lift device of a vehicle comprising said wheel lift device.

17. A modular vehicle carrier apparatus comprising:
a tow bed of sufficient dimension and constitution to carry at least one automotive vehicle thereupon;
wheel lift mating means for mating said tow bed with a wheel lift device of a wheel lift towing vehicle; and
tilting means for enabling the mated wheel lift device to tilt said tow bed into a position for vehicle loading and unloading by raising said wheel lift device, and for enabling said wheel lift device to tilt said tow bed into a position for travel by lowering said wheel lift device.

18. The apparatus of claim 17, further comprising:
travel means for enabling the mated wheel lift device to cause said tow bed and any vehicles thereon to travel as a hitch therefor, when said tow bed is in said position for travel.

19. The apparatus of claim 17, said tilting means comprising:
a wheel axle positioned such that raising said wheel lift device tilts said tow bed about said axle into said position for vehicle loading and unloading and lowering said wheel lift device tilts said tow bed about said axle into said position for travel.

20. The apparatus of claim 18, said tilting means comprising:
a wheel axle positioned such that raising said wheel lift device tilts said tow bed about said axle into said position for vehicle loading and unloading and lowering said wheel lift device tilts said tow bed about said axle into said position for travel.

21. The apparatus of claim 18, said travel means comprising:
tires secured to a wheel axle such that moving said mated wheel lift device similarly moves said tow bed.

22. The apparatus of claim 20, said travel means comprising:
tires secured to said wheel axle such that moving said mated wheel lift device similarly moves said tow bed.

23. The apparatus of claim 17, further comprising:
a bend in said tow bed positioned and angled, and located proximate a wheel axle of said modular vehicle carrier, such that a region of said tow bed forward of said bend is substantially parallel to a road when said tow bed is in said position for travel and a rear end of said tow bed aft of said bend substantially contacts said road when said tow bed is in said position for loading and unloading, when said module vehicle carrier is attached to tires thereof via said wheel axle.

24. The apparatus of claim 17, said wheel lift mating means comprising:
at least one tow leg securing to said wheel lift device using securing means for securing said tow leg to said wheel lift device.

25. The apparatus of claim 24, said securing means comprising:
lateral securing means for substantially preventing said at least one tow leg from moving laterally relative to said wheel lift device; and
vertical securing means for substantially preventing said at least one tow leg from moving vertically relative to said wheel lift device.

26. The apparatus of claim 25, said wheel lift device comprising a “T” bar, and said at least one tow leg comprising at least two tow legs:
said lateral securing means comprising a secure connection between a first said tow leg and a first end of said “T” bar, and between a second said tow leg and a second end of said “T” bar; and
said vertical securing means comprising at least one securing apparatus connected from a first position on at least one of said tow legs, securely beneath said “T” bar, to a second position on said at least one of said tow legs.

27. The apparatus of claim 17, said tow bed further comprising sufficient dimension and constitution to carry at least two automotive vehicles thereupon.

28. The apparatus of claim 23, said tow bed further comprising sufficient dimension and constitution to carry at least two automotive vehicles thereupon.

29. The apparatus of claim 17, in combination with said wheel lift towing vehicle, further comprising:
said wheel lift towing vehicle;
said wheel lift device; and
a mated connection between said tow bed and wheel lift device.

30. The apparatus of claim 29, said wheel lift towing vehicle comprising a conventional tow truck.

31. The apparatus of claim 29, said wheel lift towing vehicle comprising a vehicle comprising said wheel lift device.
